(19) United States
(12) Patent Application Publication
(10) Pub. No.: US 2023/0231366 A1
(43) Pub. Date: Jul. 20, 2023

(54) CABLE SUPPORT SYSTEM

(71) Applicant: WANHO Manufacturing, LLC., Cheshire, CT (US)

(72) Inventors: Arthur C. Gagnon, Terryville, CT (US); David Robert Elliott, Cheshire, CT (US); Manoj Kurubur Venkateshappa, Waterbury, CT (US)

(21) Appl. No.: 17/576,342

(22) Filed: Jan. 14, 2022

(51) Int. Cl. H02G 3/04; H02G 3/30

(52) U.S. Cl. CPC H02G 3/0456; H02G 3/30

(57) ABSTRACT

A cable support system includes a carrier having a base plate, two end plates, and a panel, said end plates each include an orifice and an aperture of different inner diameter, said panel includes a number of openings and a number of holes of different inner diameter, a lever includes two walls and two end pieces secured together, said walls and said end pieces each include an eyelet and a piercing of different inner diameter, a fastening member includes a stud for engaging with said orifice of said end plates and said eyelet of said walls and said end pieces of said levers, a screw hole formed in said fastening member and formed through said stud, and an inner thread formed in said fastening member and spaced from said screw hole and said stud for engaging with screws.

### BACKGROUND OF THE INVENTION

### 1. Field of the Invention

The present invention relates to a cable support system, and more particularly to a cable support system including an improved and simplified structure or configuration for solidly and stably carrying or supporting a cable in place and for preventing the cable from hanging down and for effectively eliminating the vibration and for preventing the signal interference or passive intermodulation (PIM) from being happened or occurred and for improving the signal transmission quality.

### 2. Description of the Prior Art

Telecom industry is ever changing with new technologies and inventions. As the industry deploys advanced technologies like LTE and 5G cable requirements change with it. Fiber cables no longer stop at the base of the telephone tower. Cable management adds a lot of cost to new or upgrading projects. When telecom carriers plan to expand or deploy new technology, they would like to have flexibility to do so without having to worry about cable management costs.

PIM losses were not so significant in 2G or 3G networks but with 5G PIM loss adds up which in turn results in poor quality signals. PIM can no longer be ignored due to these huge losses so more and more service providers are trying to find alternatives to traditional equipment and accessories which would mitigate PIM.

Our Universal PIM Bracket series makes cable management hassle free and gives control to the installer to decide the best configuration for a given setup with very few restrictions. Each individual component of the bracket comes with various number of ⅜″ and ¾″ holes that could be used for snap-in and threaded rod application. Universal hole pattern allows the bracket kit to be configured according to the cable management needs.

Brackets are designed to combat Passive Intermodulation. Brackets have rounder corners since sharp edges can contribute to PIM. Brackets have a 90-degree bends with gussets to eliminate vibration which is another source of PIM. Brackets are made with galvanized steel and are paired with galvanized hardware to make sure there is no dissimilar metal contact which is another major contributing factor to PIM.

Pipe Mount Bracket can be secured to round members using a U-bolt assembly making it a quick and easy installation. Bracket can accommodate various U-bolt sizes and can be mounted on pipe diameters of 2⅜″, 2⅞″ or 3½″. ¼″ thick mounting plate on the pipe mount bracket makes the bracket strong and avoids twisting under load. Rest of the bracket is made up of ⅛″ thick material to ensure all standard snap-ins work without any issues.

Main feature of the Universal PIM Bracket is its flexibility and versatility to be modified in numerous configurations without having to change installation method. It can work with various antenna and radio mount configurations and make cable management as easy as possible. It gives installer enough mounting options to be able to do cable management as neat and simple as possible. If there is a need for more mounting options installers can buy additional individual bracket components and build a new configuration to accommodate additional cable.

Typical cable support devices or systems comprise one or more beams or levers secured or connected together to carry or support a cable in place and to prevent the cable from hanging down.

For example, U.S. patent publication No. 2020/0244054 A1 to Brandvold, and U.S. patent publication No. 2021/0195784 A1 to Chen et al. disclose several of the typical cable support devices or systems each comprising one or more beams or levers secured or connected together to carry or support a cable in place and to prevent the cable from hanging down.

However, the beams or levers may not be solidly and stably secured or connected together and may become loose relative to each other and may have vibrations occurred between the beams or levers, such that signal interference or passive intermodulation (PIM) problems may have a good chance to be happened or occurred while carrying or supporting the cable on the typical cable support devices or systems.

The present invention has arisen to mitigate and/or obviate the afore-described disadvantages of the conventional cable support devices or systems.

### SUMMARY OF THE INVENTION

The primary objective of the present invention is to provide a cable support system including an improved and simplified structure or configuration for solidly and stably carrying or supporting a cable in place and for preventing the cable from hanging down and for effectively eliminating the vibration and for preventing the signal interference or passive intermodulation (PIM) from being happened or occurred and for improving the signal transmission quality.

In accordance with one aspect of the invention, there is provided a cable support system comprising a supporting member, a carrier attached to the supporting member, the carrier including a base plate, an end plate, and a panel, the panel including a plurality of openings and a plurality of holes formed in the panel, the openings including an inner diameter greater than that of the holes of the panel, a first lever including two walls and two end pieces secured together, the walls and the end pieces each including a first eyelet and a first piercing, the first eyelet including an inner diameter greater than that of the first piercing of the walls and the end pieces of the first lever, a first fastening member including a stud for engaging with either of the openings of the panel and either of the first eyelets of the walls and the end pieces of the first lever, a screw hole formed in the first fastening member and formed through the stud, and an inner thread formed in the first fastening member and spaced from the screw hole and the stud, and two screws engaged with the inner thread and the screw hole and the stud of the first fastening member for securing the carrier and the first lever together.

The end plate includes an orifice and an aperture formed in the end plate, the orifice includes an inner diameter greater than that of the aperture of the end plate for engaging with the stud of the first fastening member.

A second lever may further be provided and includes two walls and two end pieces secured together, the walls and the end pieces of the second lever each include a second eyelet and a second piercing, the second eyelet includes an inner diameter greater than that of the second piercing of the walls and the end pieces of the second lever, a second fastening member includes a stud for engaging with the orifice of the end plate and either of the second eyelets of the walls and the end pieces of the second lever, a screw hole formed in the second fastening member and formed through the stud of the second fastening member, and an inner thread formed in the second fastening member and spaced from the screw hole and the stud of the second fastening member, and two screws engaged with the inner thread and the screw hole and the stud of the second fastening member for securing the carrier and the second lever together.

The carrier includes a rounded corner structure formed between the panel and the end plate of the carrier. The carrier includes a protruded flange formed on the rounded corner structure. The first lever includes a rounded corner structure formed between either of the walls and either of the end pieces of first lever. The first lever includes a protruded flange formed on the rounded corner structure of first lever.

A third lever may further be provided and includes two walls and two end pieces secured together, the walls and the end pieces of the third lever each include a third eyelet and a third piercing formed in the third lever, the third eyelet of the third lever includes an inner diameter greater than that of the third piercing of the walls and the end pieces of the third lever, a third fastening member includes a stud for engaging with either of the openings of the panel and either of the third eyelets of the walls and the end pieces of the third lever, a screw hole formed in the third fastening member and formed through the stud of the third fastening member, and an inner thread formed in the third fastening member and spaced from the screw hole and the stud of the third fastening member, and two screws engaged with the inner thread and the screw hole and the stud of the third fastening member for securing the carrier and the third lever together.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a cable support system in accordance with the present invention;

FIG. 2 is a perspective view of the cable support system;

FIG. 3 is an enlarged partial exploded view of the cable support system;

FIGS. 4, 5 are perspective views similar to FIG. 2, illustrating the other arrangement of the cable support system;

FIG. 6 is another partial exploded view similar to FIG. 1, illustrating the further arrangement of the cable support system;

FIG. 7 is a perspective view of the cable support system as shown in FIG. 6; and

FIG. 8 is an enlarged partial exploded view of the cable support system as shown in FIGS. 6 and 7.

### DETAILED DESCRIPTION OF THE PREFERRED EMBODIMENT

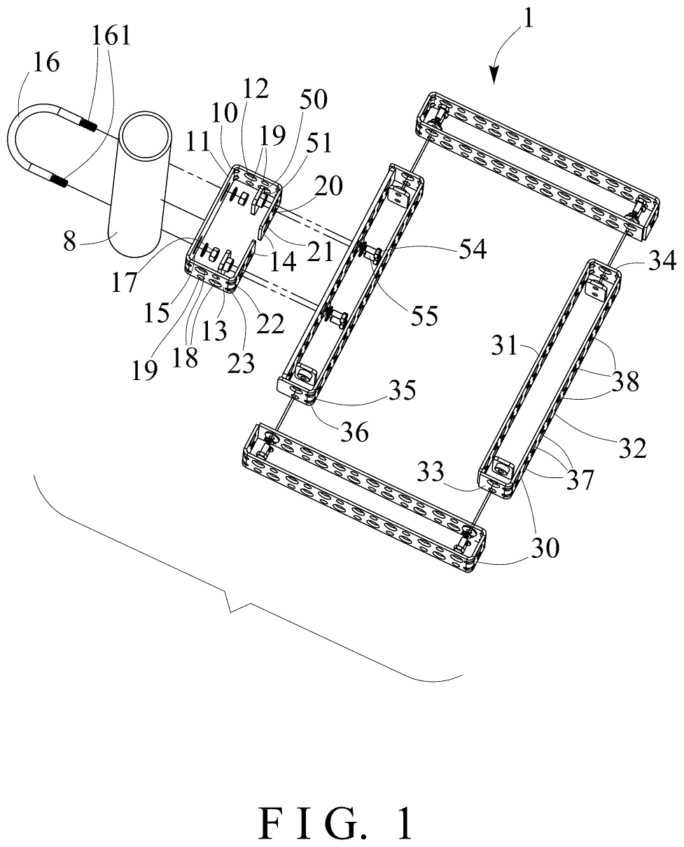

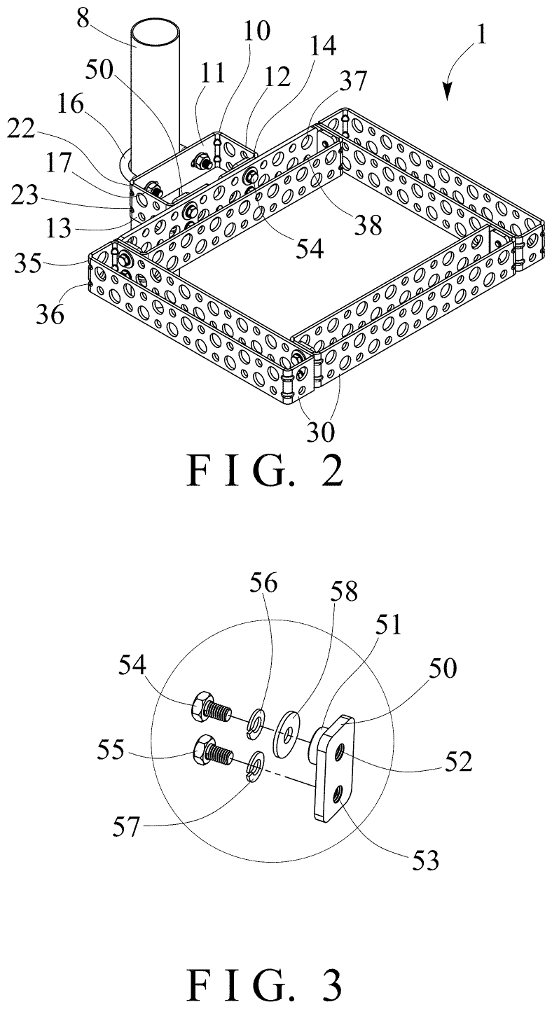

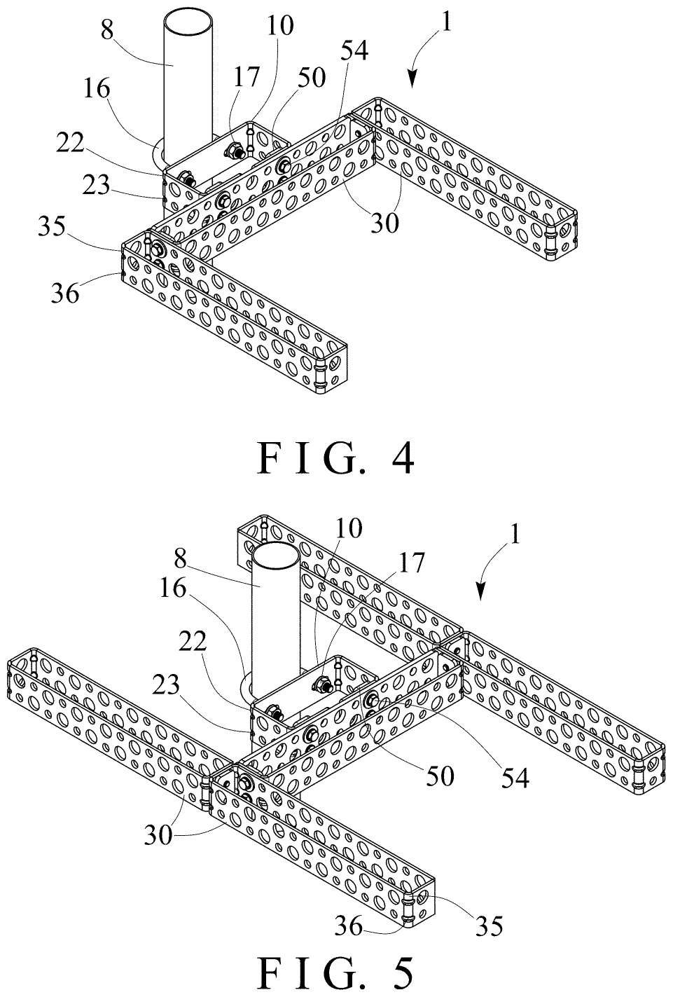

Referring to the drawings, and initially to FIGS. 1-5, a cable support system 1 in accordance with the present invention comprises a base or carrier 10 including a square or rectangular shape or structure or configuration having a base plate 11, two end plates 12, 13 parallel to each other and perpendicular to the base plate 11, and one or more (such as two) flaps or panels 14 parallel to the base plate 11 and perpendicular to the end plates 12, 13 in order to form a C-shaped or square or rectangular shape or structure or configuration, in which the base plate 11 includes one or more (such as two) oblong holes 15 formed therein for receiving or engaging with a fastener 16, such as a C or U shaped fastener 16 which includes two legs 161 to engage with the oblong holes 15 of the base plate 11 and which may secure or couple the base plate 11 of the carrier 10 to the supporting member 8, such as a supporting column 8, with such as with nuts 17 or catches or latches or the like. The end plates 12, 13 of the carrier 10 each include one or more (such as two) orifices 18 and one or more (such as two) apertures 19 formed therein, in which the orifices 18 include an inner diameter greater than that of the apertures 19 of the end plates 12, 13 of the carrier 10. The panels 14 of the carrier 10 each include a number of openings 20 and holes 21 formed therein, in which the openings 20 include an inner diameter greater than that of the holes 21 of the panel 14 of the carrier 10 and arranged in a stagger way relative to the holes 21 of the panel 14 of the carrier 10.

It is preferable that the carrier 10 includes a rounded corner structure 22 formed or provided between the panel 14 and the end plates 12, 13 of the carrier 10 respectively, and includes one or more cuts or notches 23 formed or provided on the rounded corner structure 22 for eliminating the vibration and for preventing the signal interference or passive intermodulation (PIM) from being happened or occurred.

The cable support system 1 further includes one or more, such as a first and at least one second beams or arms or frames or levers 30 each having two longer walls 31, 32 that are parallel to each other, and two shorter end pieces 33, 34 that are parallel to each other and perpendicular to the walls 31, 32 in order to form a square or rectangular shape or structure or configuration, and the levers 30 each include a rounded corner structure 35 formed or provided between the walls 31, 32 and the end pieces 33, 34 respectively, and includes one or more cuts or notches 36 formed or provided on the rounded corner structure 35 for eliminating the vibration and for preventing the signal interference or passive intermodulation (PIM) from being happened or occurred, and includes a number of eyelets 37 and piercings 38 formed in the walls 31, 32 and the end pieces 33, 34, in which the eyelets 37 include an inner diameter greater than that of the piercings 38 of the walls 31, 32 and the end pieces 33, 34 of the levers 30 for aligning with the orifices 18 and the apertures 19 of the end plates 12, 13 of the carrier 10 and/or the openings 20 and the holes 21 of the panel 14 of the carrier 10 respectively. The eyelets 37 and the piercings 38 in the walls 31, 32 are arranged in a stagger way relative to each other.

The cable support system 1 further includes one or more, such as a first and at least one second fastening members 50 for securing or coupling to the carrier 10 and the levers 30 together, for example, the fastening members 50 each include a protrusion or stud 51 extended therefrom (FIG. 3) for engaging with or into the orifice 18 of the end plates 12, 13 of the carrier 10 and also for engaging with or into the eyelet 37 of the walls 31, 32, and/or of the end pieces 33, 34 of the levers 30, or for engaging with or into the orifice 18 of the panel 14 of the carrier 10 and also for engaging with or into the eyelet 37 of the walls 31, 32, and/or of the end pieces 33, 34 of the levers 30.

As shown in FIG. 3, the fastening members 50 each include a screw hole 52 formed therein and also formed through the stud 51, and another screw hole or inner thread 53 formed therein and offset or spaced or separated from the screw hole 52 and the stud 51 for engaging with screws 54, 55 or bolts or catches or latches or fasteners or the like and/or the spring washers 56, 57 and the washers 58 for solidly and stably securing or coupling or anchoring or retaining or positioning the carrier 10 and the levers 30 together. It is preferable that the carrier 10 and the levers 30 are made of galvanized steel or the like, and will not be contacted with the other metallic materials.

It is to be noted that the formation or the provision of the rounded corner structure 22 and/or the notches 23 in the carrier 10, and/or the rounded corner structure 35 and/or the notches 36 in the levers 30 may be used or provided for eliminating the vibration and for preventing the signal interference or passive intermodulation (PIM) from being happened or occurred. The formation or the provision of the stud 51 on the fastening member 50 may be used for engaging with or into the orifice 18 of the end plates 12, 13 and/or the panel 14 of the carrier 10 and the eyelet 37 of the walls 31, 32, and/or of the end pieces 33, 34 of the levers 30 may solidly and stably secure or couple or anchor or retain or position the carrier 10 and the levers 30 together.

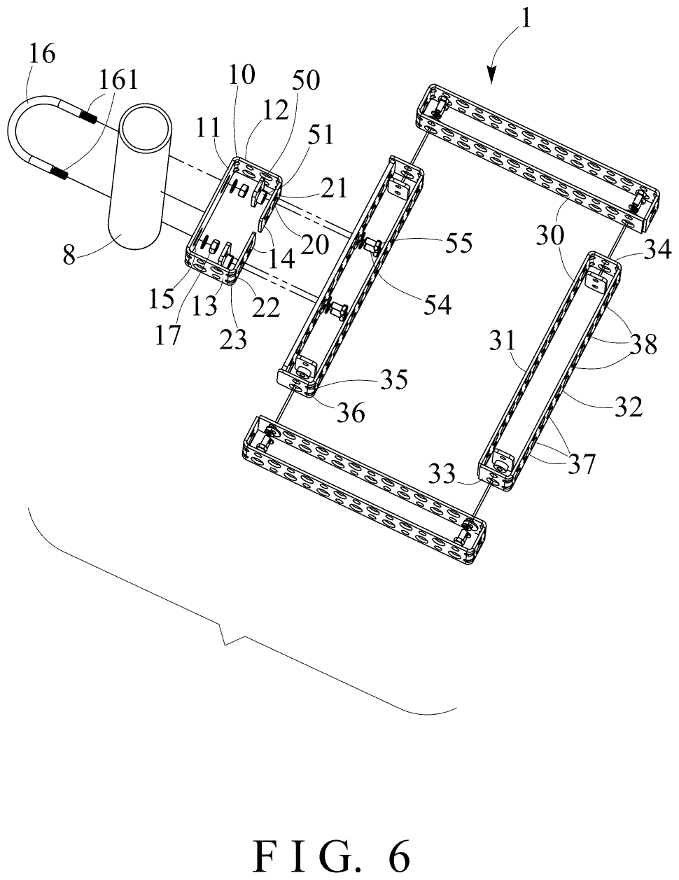

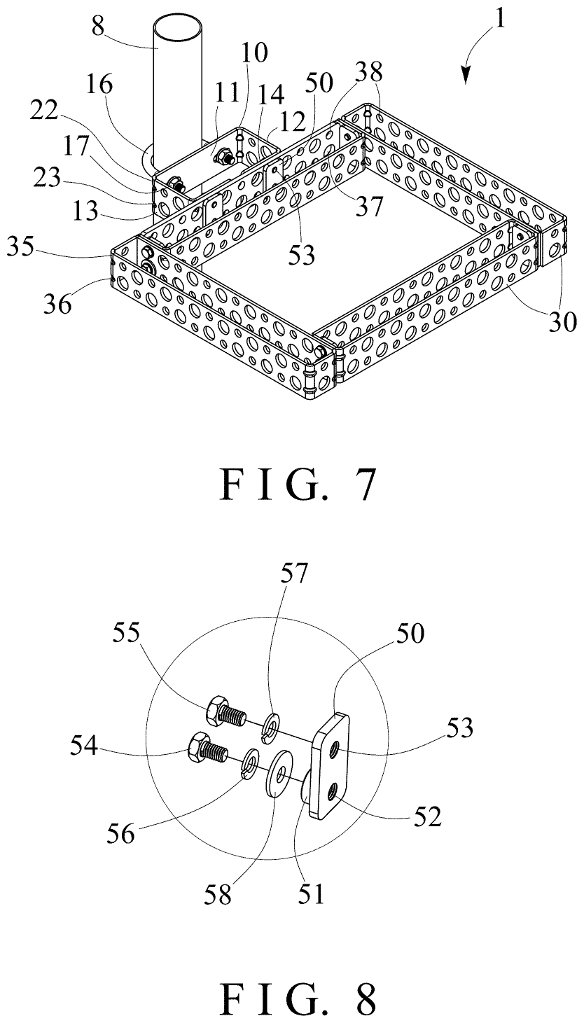

As shown in FIGS. 6-8, the fastening members 50 may be disposed or arranged up side down relative to that shown in FIGS. 1-5 for solidly and stably securing or coupling or anchoring or retaining or positioning the carrier 10 and the levers 30 together.

Accordingly, the cable support system in accordance with the present invention includes an improved and simplified structure or configuration for solidly and stably carrying or supporting a cable in place and for preventing the cable from hanging down and for effectively eliminating the vibration and for preventing the signal interference or passive intermodulation (PIM) from being happened or occurred and for improving the signal transmission quality.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A cable support system comprising:
a supporting member,
a carrier attached to said supporting member, said carrier including a base plate, an end plate, and a panel, said panel including a plurality of openings and a plurality of holes formed in said panel, said openings including an inner diameter greater than that of said holes of said panel,
a first lever including two walls and two end pieces secured together, said walls and said end pieces each including a first eyelet and a first piercing, said first eyelet including an inner diameter greater than that of said first piercing of said walls and said end pieces of said first lever,
a first fastening member including a stud for engaging with either of said openings of said panel and either of said first eyelets of said walls and said end pieces of said first lever, a screw hole formed in said first fastening member and formed through said stud, and an inner thread formed in said first fastening member and spaced from said screw hole and said stud, and
two screws engaged with said inner thread and said screw hole and said stud of said first fastening member for securing said carrier and said first lever together.

2. The cable support system as claimed in claim 1, wherein said end plate includes an orifice and an aperture formed in said end plate, said orifice includes an inner diameter greater than that of said aperture of said end plate for engaging with said stud of said first fastening member.

3. The cable support system as claimed in claim 2 further comprising a second lever including two walls and two end pieces secured together, said walls and said end pieces of said second lever each including a second eyelet and a second piercing, said second eyelet including an inner diameter greater than that of said second piercing of said walls and said end pieces of said second lever, a second fastening member including a stud for engaging with said orifice of said end plate and either of said second eyelets of said walls and said end pieces of said second lever, a screw hole formed in said second fastening member and formed through said stud of said second fastening member, and an inner thread formed in said second fastening member and spaced from said screw hole and said stud of said second fastening member, and two screws engaged with said inner thread and said screw hole and said stud of said second fastening member for securing said carrier and said second lever together.

4. The cable support system as claimed in claim 1, wherein said carrier includes a rounded corner structure formed between said panel and said end plate of said carrier.

5. The cable support system as claimed in claim 4, wherein said carrier includes a protruded flange formed on said rounded corner structure.

6. The cable support system as claimed in claim 1, wherein said first lever includes a rounded corner structure formed between either of said walls and either of said end pieces of first lever.

7. The cable support system as claimed in claim 6, wherein said first lever includes a protruded flange formed on said rounded corner structure of first lever.

8. The cable support system as claimed in claim 1 further comprising a third lever, said third lever including two walls and two end pieces secured together, said walls and said end pieces of said third lever each including a third eyelet and a third piercing formed in said third lever, said third eyelet of said third lever including an inner diameter greater than that of said third piercing of said walls and said end pieces of said third lever, a third fastening member including a stud for engaging with either of said openings of said panel and either of said third eyelets of said walls and said end pieces of said third lever, a screw hole formed in said third fastening member and formed through said stud of said third fastening member, and an inner thread formed in said third fastening member and spaced from said screw hole and said stud of said third fastening member, and two screws engaged with said inner thread and said screw hole and said stud of said third fastening member for securing said carrier and said third lever together.
